(19) United States
(12) Patent Application Publication
(10) Pub. No.: US 2023/0225354 A1
(43) Pub. Date: Jul. 20, 2023

(54) CANDY AND METHOD FOR MAKING

(71) Applicant: Gregory J. Yurko, Escondido, CA (US)

(72) Inventor: Gregory J. Yurko, Escondido, CA (US)

(21) Appl. No.: 17/578,279

(22) Filed: Jan. 18, 2022

(51) Int. Cl. A23G 3/54; A23G 3/36

(52) U.S. Cl. CPC A23G 3/54; A23G 3/36

(57) ABSTRACT

A rock and roll candy bar. A layer of peanut butter is sandwiched between two banana chips. A thin layer of chocolate surrounds the two banana chips and the layer of peanut butter. A decorative edible image is applied to the thin layer of chocolate. In a preferred embodiment the banana chips are cut into the shape of guitar picks. Also, in a preferred embodiment the decorative edible image is a symbol representing rock and roll.

### BACKGROUND OF THE INVENTION

Rock and roll as a form of music and as a cultural phenomenon is deeply embedded into the fabric of America. Since the 1950's, Americans young and old have listened to and have become enthralled with rock and roll music and the exciting and captivating lifestyle of its artists. Starting at the birth of rock and roll and up until this very day, rock and roll fans have spent exorbitant amounts of money and time buying music, attending rock concerts and buying rock and roll paraphernalia. Indeed, just recently Bruce Springsteen sold his entire catalog of music, including his master recordings and song publishing catalog, to Sony Music Entertainment in a blockbuster deal that reportedly is worth $500 million.

There are many symbols of rock and roll, such as fast cars, juke boxes, drum kits and electric guitars. One of the strongest symbols of rock and roll is the guitar pick. For example, FIG. 1 shows guitar pick 1. Guitar pick 1 is an example of the 351 shaped guitar pick. Although there are also other shapes known in the prior art, the 351 shaped pick is the most popular pick used by rock and roll guitarists.

Elvis Presley is a very famous rock and roll star, and as such, is often referred to as the King of Rock and Roll. The famous peanut butter and banana sandwich is most always associated with Elvis Presley.

Banana chips are dried-out crisp slices of bananas that are usually consumed as a snack. The banana slices may be deep fried or baked. Some banana chips may just be formed by thinly slicing a banana and then allowing the chip to dry out. A popular shape of the banana chip is circular. There are several banana chip recipes that are known, each producing a dried banana chip with its own flavor.

Edible images are known in the prior art. Edible images include images that are printed with edible ink onto edible sheets. Typically, a computer in communication with a printer having edible ink is utilized to print the edible image onto an edible sheet. These sheets are then placed on a variety of confectionery products such as cakes, cookies, and cupcakes.

An edible image may also be applied directly to the confectionary product in a variety of ways. For example, an edible image may be silk screened or stamped onto the confectionary product or applied directly by hand in some other fashion.

What is needed is a candy that represents rock and roll and a method for making the candy.

### SUMMARY OF THE INVENTION

The present invention provides a rock and roll candy bar. A layer of peanut butter is sandwiched between two banana chips. A thin layer of chocolate surrounds the two banana chips and the layer of peanut butter. An edible image is applied to the thin layer of chocolate. In a preferred embodiment the banana chips are cut into the shape of guitar picks. Also, in a preferred embodiment the edible image is a symbol representing rock and roll.

### BRIEF DESCRIPTION OF THE DRAWINGS

FIG. 1 shows a prior art guitar pick.

FIG. 2 shows a preferred embodiment of the present invention.

FIG. 3 shows the internal components of a preferred candy.

FIGS. 4 and 5 show alternate decorative edible images.

FIGS. 6 and 7 show another preferred embodiment of the present invention.

### DETAILED DESCRIPTION OF THE PREFERRED EMBODIMENTS

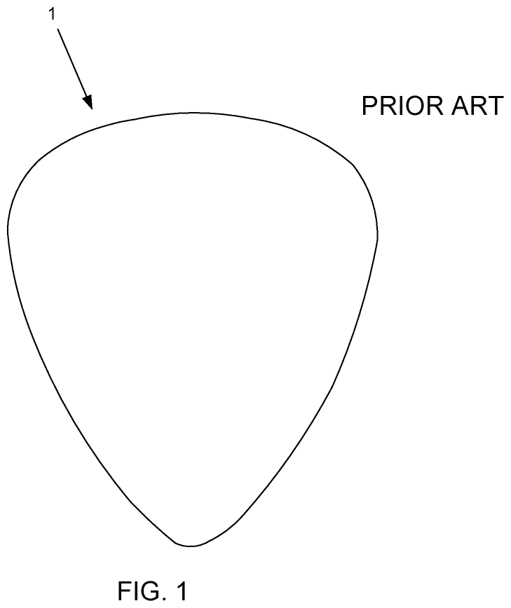

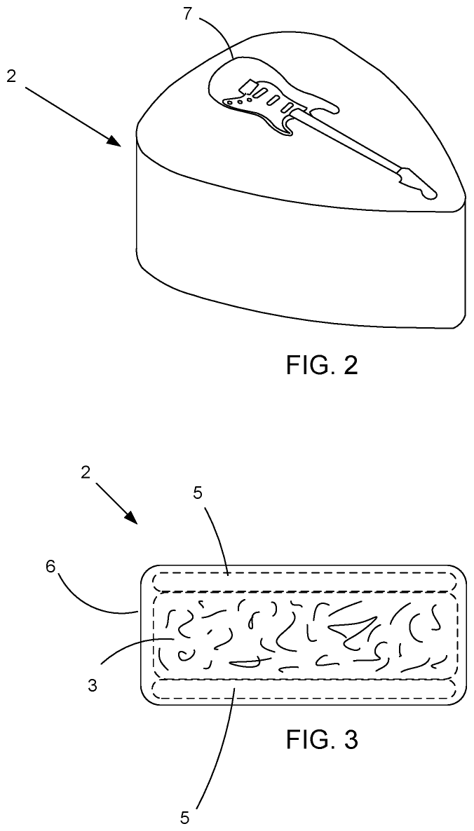

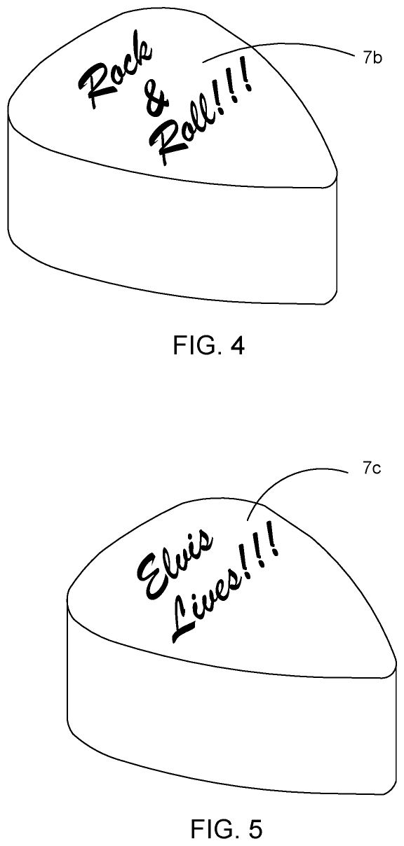

FIG. 2 shows a perspective view of candy 2 and FIG. 3 shows a side view of candy 2. In a preferred embodiment candy 2 has the shape of a guitar pick similar to the shape of prior art pick 1 (FIG. 1). The guitar pick shape is attractive to the consumer in that it brings up an immediate mental association with rock and roll music and culture.

### Method of Making a Preferred Candy

In FIG. 3, the user has first cut banana chips 5 into the general shape of guitar pick. Each banana chip 5 is approximately 0.10 inches thick. The user has then spread a 0.25-inch-thick layer of peanut 3 between banana chips 5. The user has then covered the banana chips and the peanut butter center with a thin layer of chocolate 6 so that the entire candy is covered chocolate. Finally, the user has applied rock and roll related edible image 7 to the top of candy 2. For example, as shown in FIG. 2, the user has applied edible image 7 showing an electric guitar.

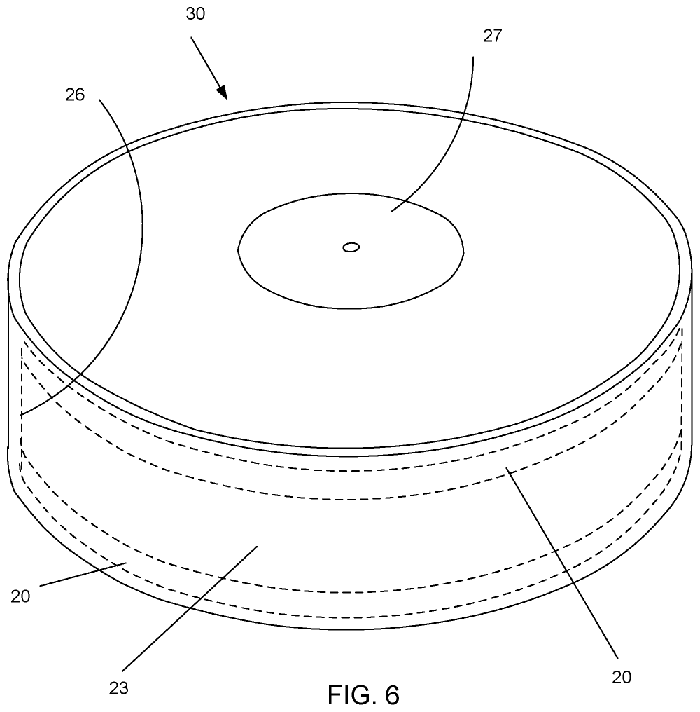

It should be noted that rock and roll edible images can be of a variety of types, including images (such as image 7 shown in FIG. 2) or rock and roll related text. For example, FIG. 4 shows image 7b stating “Rock & Roll!!!” and FIG. 5 shows image 7c stating “Elvis Lives!!!”.

### Other Preferred Embodiments

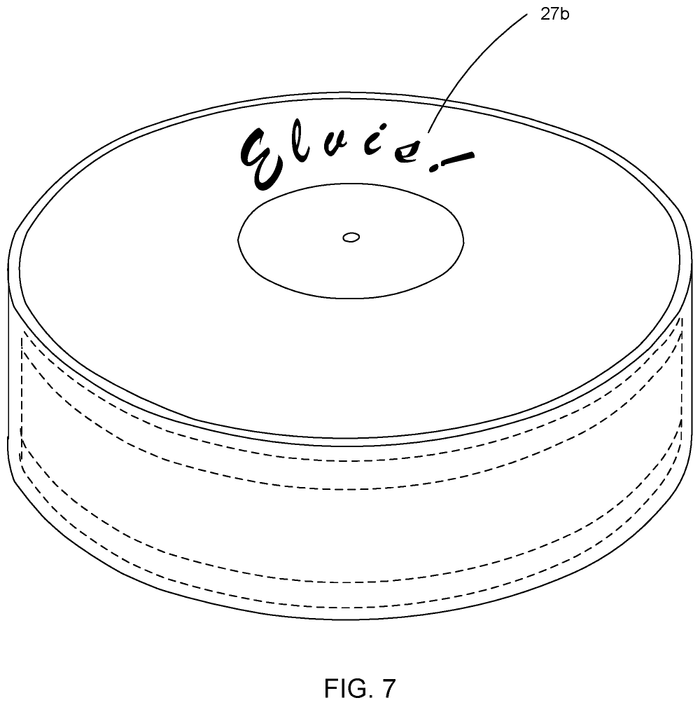

In the above-described preferred embodiment, it was explained how banana chips are first cut into the shape of a guitar pick. In another preferred embodiment, it is possible to make the present invention without cutting the banana chips. For example, as shown in FIG. 6, circular banana chips 20 are not cut. Instead, they are left round. They are left round because a record album similarly has a round shape.

In FIG. 6, user has spread a 0.25-inch-thick layer of peanut 23 between round banana chips 20. The user has then covered the banana chips and the peanut butter center with a thin layer of chocolate 26 so that the entire candy is covered in chocolate. Finally, the user has applied rock and roll related edible image 27 to the top of candy 30. For example, as shown in FIG. 6, image 27 is such that it makes the top of candy 30 appear to look like a record album.

As with the earlier described preferred embodiment, it should be noted that rock and roll edible images can be of a variety of types, including an image combined with rock and roll related text. For example, FIG. 7 shows edible image 27b showing the image of record album combined with the text “Elvis!”.

Although the above-preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A rock and roll candy bar, comprising:
A. two banana chips,
B. a layer of peanut butter sandwiched between said two banana chips,
C. a thin layer of chocolate surrounding said two banana chips and said layer of peanut butter, and
D. a decorative edible image applied to said thin layer of chocolate.

2. The rock and roll candy bar as in claim 1, wherein said decorative edible image is a symbol.

3. The rock and roll candy bar as in claim 2, wherein said symbol is related to rock and roll.

4. The rock and roll candy bar as in claim 1, wherein said decorative edible image is text.

5. The rock and roll candy bar as in claim 4, wherein said text is related to rock and roll.

6. The rock and roll candy bar as in claim 1, wherein each banana chip of said two banana chips is in the shape of a guitar pick.

7. The rock and roll candy bar as in claim 1, wherein each banana chip of said two banana chips is round.

8. A method for making a rock and roll candy bar, comprising the steps of:
A. acquiring two banana chips,
B. applying a layer of peanut butter between said two banana chips,
C. applying a thin layer of chocolate around said two banana chips and said layer of peanut butter, and
D. applying a decorative edible image to said thin layer of chocolate.

9. The method as in claim 8, wherein said decorative edible image is a symbol.

10. The method as in claim 9, wherein said symbol is related to rock and roll.

11. The method as in claim 8, wherein said decorative edible image is text.

12. The method as in claim 11, wherein said text is related to rock and roll.

13. The method as in claim 8, wherein each banana chip of said two banana chips is in the shape of a guitar pick.

14. The method as in claim 8, wherein each banana chip of said two banana chips is round.
